(19) United States
(12) Patent Application Publication
(10) Pub. No.: US 2008/0307025 A1
(43) Pub. Date: Dec. 11, 2008

(54) LOCATION DETERMINATION IN SENSOR NETWORKS USING TIME-WINDOW ALGORITHM

(75) Inventor: Stanislav Licul, Damascus, MD (US)

Correspondence Address: DLA PIPER LLP (US);ATTN: PATENT GROUP, 500 8th Street, NW, WASHINGTON, DC, 20004-2131, US

(73) Assignee: ZYLAYA CORPORATION, Gaithersburg, MD (US)

(21) Appl. No.: 11/760,962

(22) Filed: Jun. 11, 2007

(51) Int. Cl. G06F 17/14; G06F 17/10

(52) U.S. Cl. 708/308; 708/400; 708/403

(57) ABSTRACT

A network system and a method of determining a location of a transmitter are described. The method includes reading a signal strength of a signal transmitted by the transmitter by each of a plurality of receivers, at each frequency in a plurality of frequencies, extracting phase information using an amplitude of the signal at each of the plurality of frequencies, and applying a transform (such as a Fourier Transform) to the signal in the frequency domain to obtain a representation of the signal in the time-domain. The method further includes applying a time window to the signal in the time-domain to eliminate reflected multipath signals that arrive to the respective receivers later than a line-of-sight signal to obtain a windowed signal in the time domain, and calculating a location of the transceiver using the windowed time domain signal.

### BACKGROUND

### Field of the Invention

The present invention relates generally to data communication, and relates specifically to a method and system for locating a transceiver using a time-window algorithm in a network system.

### BRIEF SUMMARY

An aspect of the present invention is to provide a network system and a method of determining allocation of a transmitter. The method includes reading a signal strength of a signal fitted by the transmitter by each of a plurality of receivers, at each frequency in a plurality of frequencies, extracting phase information using an amplitude of the signal at each of the plurality of frequencies, and applying a transform (such as a Fourier Transform) to the signal in the frequency domain to obtain a representation of the signal in the time-domain. The method further includes applying a time window to the signal in the time-domain to eliminate reflected multipath signals that arrive to the respective receivers later than a line-of-sight signal to obtain a windowed signal in the time domain, and calculating a location of the transceiver using the windowed time domain signal.

Throughout this application, including the claims, the word ‘tansceiver’ is intended to mean a transmitter, a receiver or a combination transmitter/receiver.

### BRIEF DESCRIPTION OF THE DRAWINGS

FIG. 1 illustrates a network system in an uplink configuration, according to an embodiment of the present invention; and

FIG. 2 shows a flow diagram of a time-widow-algorithm for the determination of a location of a transceiver in a network according to an embodiment of the present invention.

### DESCRIPTION OF EMBODIMENTS OF THE INVENTION

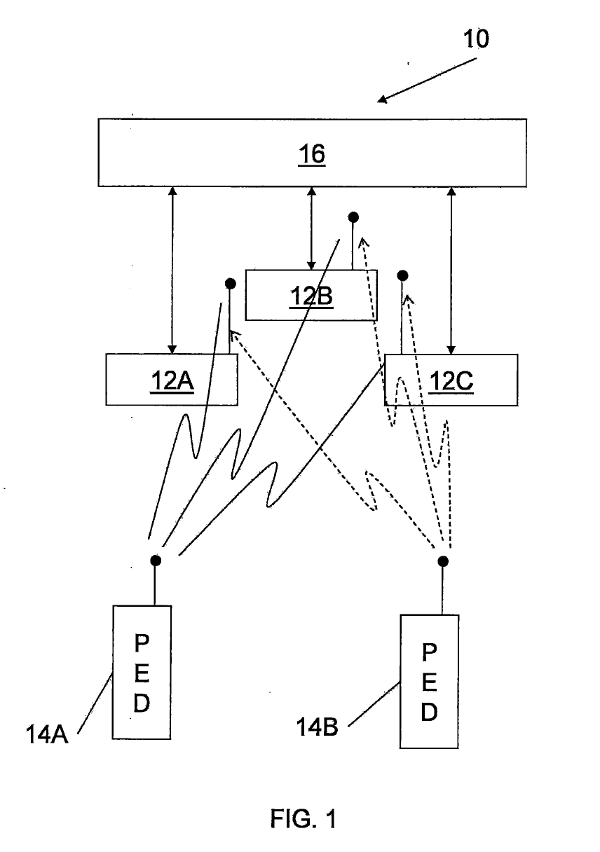

FIG. 1 illustrates a network system 10 in an uplink configuration, according to an embodiment of the present invention. The network system 10 comprises individual base receive stations or wireless sensors 12A, 12B and 12C in communication wirelessly with transceivers (e.g., receivers) or personal emergency devices (PED) 14A and, 14B. In one embodiment, the transmitter (e.g., PED 14A) communicates with each of the wireless sensors 12A, 12B and 12C in a wide band channel comprising a plurality of frequencies f1 through fN in a specific range of frequencies [f1 . . . fN]. For example, in one embodiment, the frequencies f1 through fN can be frequencies in the ISM band 902 MHz to 928 MHz in which f1 is centered around 902 MHz, f2 is centered around 903 ME, f3 is centered around 904, . . . and fN is centered around 928 MHz, where N is equal to 27. However, any frequency band can be selected. In addition, any number of frequencies inside the frequency band can be used.

The network system further includes a command and control center 16. The command and control center 16 is in communication with the wireless sensors 12A, 12B, and 12C. The wireless sensors 12A, 12B and 12C receive and pass on upstream data signals from personal emergency devices PED 14A and PED 14B to the command and control center 16. In addition, the wireless sensors 12A, 12B and 12C can receive downstream data signals from the command and control center 16 and relay the downstream data signals to the personal emergency devices 14A and 14B.

In the process of transmitting a signal from a transmitter, for example from PED 14A to a receiver, for example, wireless sensor 12A, the signal may encounter reflections in the transmission path. In this situation, the receiver wireless sensor 12A may receive a plurality of signals (for example, two signals) each of which carries the same information but shifted in time. As a result, the signal received by the receiver wireless sensor 12A would be a sum of the two signals shifted in time relative to each other. For example, one received signal would correspond to a non-reflected signal while the other signal would correspond to a reflected signal. The difference in time between the two signals corresponds to the difference between the arrival time of the non-reflected signal and the arrival time of the reflected signal to the receiver due to path differences or multipath differences between the two signals. This difference in time creates uncertainty in the location determination of the transmitter (e.g., PED 14A).

The signal received by the receiver (e.g., sensor 12A) is preserved in the time domain but may appear having a certain standard deviation around a mean frequency in the frequency domain which is typically in the range of approximately 7 dB to approximately 12 dB. The “broadening” of the signal in the frequency domain due to the multipath reflections results in an uncertainty in the determination of the location of the transmitter based on the received signal strength indication (RSSI).

By reducing the received signal standard deviation, the estimation of the location of the transmitting device (e.g., PED 14A) can be substantially improved. Since, multipath reflection can occur in any setting, a way to reduce or even substantially eliminate the effect of the multipath reflection on a signal is by using a time window.

In the time domain, line-of-sight or direct signals and multipath reflection component signals which are delayed with respect to the direct signals can be discriminated. For example, by applying an appropriate time-window, the delayed or late arriving multipath components can be eliminated. As a result, the signal intensity variation at the front end, i.e., at the receiver end (for example at receiver 12A), can be reduced which ultimately allows to improve the precision of locating the transmitter (e.g., PED 14A).

In order to take advantage of the time-window selection for discriminating the multipath component signals, a Fourier Transform is performed to transform a signal which is in the frequency domain into a signal in the time domain. However, in order to perform the Fourier Transform so as to obtain a signal in the time domain which would provide information on the multipath signals, signal phase information may be needed. Otherwise, without the phase information, only the RSSI value would be obtained in the time domain. Indeed, the separation in time of the different signals would not be possible without the phase.

In order to extract, obtain or otherwise compute the phase information, available frequency channels can be sampled over a certain range of frequencies and a Hilbert Transform can be applied on each of the sampled channels

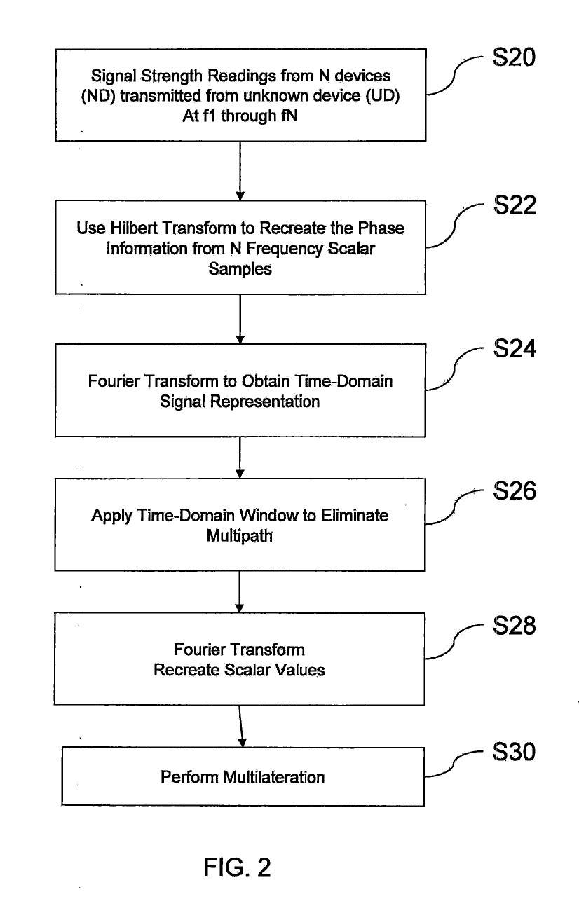

FIG. 2, shows a flow diagram of a time-window algorithm for the determination of location of a transmitter in a network, according to an embodiment of the present invention. In one embodiment, the algorithm is executed by the command and control center 16. Alternatively, a dedicated separate computing device in communication with the control center 16 may also be provided to execute the algorithm. The algorithm comprises, reading or sampling a signal strength of a wideband signal transmitted by the transmitter (e.g., PED 14A) by each of the wireless sensors 12A, 12B and 12C at all frequencies f1 through fn in a specific range of frequencies [f1 . . . fN], at step S20. For example, in one embodiment, the frequencies f1 through fN can be frequencies in the ISM band 902 MHz to 928 MHz in which f1 is centered around 902 MHz, f2 is centered around 903 MB, f3 is centered around 904 MHz, . . . , and fN is centered around 928 MHz, where N is equal to 27. In this example, the frequency bandwidth is 26 MHz (928 MHz-902 MHz). However, any frequency band can be selected. In addition, it must be appreciated that the number of frequencies read or sampled in the wideband signal can be increased or decreased. The greater the number of sampling frequencies the more precise is the determination of the location of the transmitter. However, the greater the number of frequencies read or sampled, the longer the computing time period for determining the location of the Knitter. Therefore, a compromise between obtaining amore precise location result and increasing computing time may be negotiated according to a specific situation.

The algorithm further comprises recreating the phase information from N frequency scalars, at step S22. In order to extract the phase information, a Hilbert transform is applied to recreate the phase information from N frequency scalar samples (for example, from 27 scalar samples).

A complex analytic signal can be expressed as follows:

R(ω)=X(ω)+jY(ω)=X(ω)+jH(X(ω) (1)

where H(X(ω)) denotes the Hilbert transform of X(ω), and X(ω), and ω is the angular frequency which is related to frequency f by the relationship ω=2πf. Hence, for analytic signals, the real part of the signal X (ω) is sufficient to reconstruct the missing imaginary part of the signal since the imaginary part is the Hilbert transform of the real part. However, in scalar frequency domain measurements, the measurable quantity is the magnitude of the complex Fourier transform of the signal and not the real part of the signal.

The complex analytic signal can also be expressed as follows:

R(ω)=|R(ω)|exp jΦ(ω) (2)

where |R(ω)| is the amplitude of the signal and Φ(ω) is the phase of the signal.

By applying a natural logarithm operator on the analytic signal in expression (2), the magnitude and the phase of the transfer function can be expressed as the real and imaginary parts of the transformed response, as follows:

R̅(ω)=ln(R(ω)=ln[|R(ω)|exp jΦ(ω)]=ln|R(ω)|+jΦ(ω) (3)

The function R̅(ω) represents the Fourier Transform of another signal that can also satisfy the causality and analyticity condition if and only if all the poles and the zeros of R(ω) lie inside the unit circle in the complex plane. In which case equation (1) can be applied to equation (3), as follows.

R̅(ω)= X̅(ω)+jH( X̅(ω))=ln|R(ω)|+jΦ(ω) (4)

From equation (4), the values of X̅(ω) and Φ(ω) can be obtained

X̅(ω)=ln|R(ω)| (5)

H( X̅(ω))=Φ(ω) (6)

By substituting the value of X̅(ω) obtained in equation (5) into equation (6), the phase can be rewrite as follows:

Φ(ω)=H(ln|R(ω)|) (7)

Using equation (2) and equation (7), the complex spectrum of an analytic signal can be expressed as follows:

R(ω)=|R(ω)|exp j[H(ln|R(ω)|)] (8)

As shown in equation (7), the phase is equal to the Hilbert Transform of the natural logarithm of the signal. The phase Φ(ω) obtained in equation (7) represents the minimum phase of R(ω)). If all poles and zeros of R(ω) do not lie inside the unit circle in the complex plane, a non-minimum phase contribution should be added to the minimum phase obtained in equation (7).

In the present case, at step S22, using the Gilbert transform of the natural logarithm of the frequency samples, the phase is computed. Specifically, the phase is computed using the amplitude of the signals at the respective frequency components f1, f2, f3, . . . , fN.

The phase can be computed using the following equation:

$$H \text{(} ln \vert R ( ω ) \vert = \frac{1}{π} {\int }_{- ∞}^{+ ∞} \frac{ln \vert R ( ɛ ) \vert}{ω - ɛ} d ɛ \qquad ( 9 )$$

Following the computation of the phase at step S22, a Fourier transform is applied to the signal in the frequency domain to obtain a representation of the signal in the time domain, at step S24. Specifically, a Fourier Transform is applied to the signal in the frequency domain to obtain a signal in the time domain as follows:

$$R ( t ) = \frac{1}{\sqrt{2 π}} {\int }_{- ∞}^{+ ∞} R ( ω ) {e}^{jω t} d ω \qquad ( 10 )$$

By substituting equation (8) into equation (10), equation (10) can be rewritten as follows:

$$R ( t ) = \frac{1}{\sqrt{2 π}} {\int }_{- ∞}^{+ ∞} \{ \vert R ( ω ) \vert {e}^{j [ H ( In \vert R ( ω ) \vert ) ]} \} {e}^{jω t} d ω \qquad ( 11 )$$

Equation (11) simplifies as follows:

$$R ( t ) = \frac{1}{\sqrt{2 π}} {\int }_{- ∞}^{+ ∞} \vert R ( ω ) \vert {e}^{j \{ ω t + [ H ( In \vert R ( ω ) \vert ) ] \}} d ω \qquad ( 12 )$$

were H(ln|R(ω)|) is the phase that was obtained previously via equation (9), at step S22.

The Fourier Transform in the time domain corresponds to a recombination of all the frequency components. Each component is a complex sinusoid of the form e^{jωt} whose amplitude is proportional to |R(ω)| and whose initial phase angle at t=0 is H(ln|R(ω)|).

Equation (12) can also be rewritten using the frequency f instead of the angular frequency ω, as follows:

$$R ( t ) = {\int }_{- ∞}^{+ ∞} \vert R ( f ) \vert {e}^{j \{ 2 π ft + 2 π [ H ( ln \vert R ( f ) \vert ) ] \}} d f \qquad ( 13 )$$

Although a Fourier Transform is described herein for transforming the signal from a frequency domain into a time domain, it must be appreciated that other known types of transformations may be utilized including a Laplace Transform, a Wavelet Transform, etc

Once the time domain representation of the signal R(t) is obtained, at step 24, the algorithm proceeds by applying a time domain window to eliminate or reduce multipath, at step S26. This is performed, for example, by selecting an appropriate window that includes the direct signal, i.e., line-of-sight signal, but eliminates substantially the reflected multipath signals that arrive to the respective receivers (e.g., wireless sensors 12A, 12B and 12C) with a time delay. The window is judiciously selected to be narrow enough so as to discriminate between line-of-sight signals and multipath components which arrive at later times while insuring that the window is not overly narrow to avoid, reducing the RSSI of the line-of-sight signal. Ideally, the time window is selected from the bring of the line-of-sight signal to an end of the line-of-sight signal. However, because reflected multipath signals that arrive later to the receivers may be contiguous to, the line-of-sight signal, it may be difficult to distinguish the end of the line-of-sight signal. Hence, a cutoff time may be selected from which the reflected multipath signals may be eliminated or zeroed. For example, in one embodiment, the cutoff time can be selected as being the time at which the amplitude of the line-of-sight, signal decreases to a level between 10% to 30% of the maximum amplitude of the line-of-sight signal. In another embodiment, the cutoff time can be selected as being the sum of the time corresponding to the maximum amplitude of the line-of-sight signal and the difference in time between the time corresponding to the maximum amplitude of the line-of-sight signal and the beginning of the line-of-sight signal. In yet another embodiment, the time window car be computed by adding the total time required for the arrival of the line-of-sight signal to a half of the inverse of the frequency bandwidth. For example, if the bandwidth is 26 MEW, the time window is equal to the total time required for the arrival of the line-of-sight signal plus approximately 19 nanoseconds. This time window can lead to a distance resolution of approximately 12 meters.

After substantially eliminating the multipath components of the signal using an appropriate window, at step S26, the algorithm progresses by performing an inverse Fourier Transform on the signal in the time domain to return to a signal in the frequency domain and recreate the frequency scalar values R(ω) which correspond to the RSSI of the “line of sight” signal, at step S28. The inverse Fourier Transform of the time-windowed R(t) signal can be written as follows:

$$R ( ω ) = \frac{1}{\sqrt{2 π}} {\int }_{- ∞}^{+ ∞} R ( t ) {e}^{- jω t} d t \qquad ( 14 )$$

Then, the algorithm proceeds to perform a multilateration procedure using any available multilateration technique, at t S30. In a multilateration procedure, at least three receivers (e.g., the three wireless sensors 12A, 12B and 12C) must be used to determine the location of a transmitter (e.g., PED 14A or PED 14B). By measuring the time difference of arrival (TDOA) of a signal from a transmitter at the three or more receiver sites, the location of the transmitter can be determined.

If a signal is transmitted from, for example PED 14A, it will arrive at slightly different times at two spatially separated receiver sites, for example arrive at different times at wireless sensor 12A and wireless sensor 12B which are spatially separated and located at different physical locations. However, for given locations of only two receivers (e.g., wireless sensors 12A and 12B), a whole series of transmitters would give the same measurement of TDOA. For example, given two receiver locations (location of wireless sensor 12A and location of wireless sensor 12B) and a known TDOA, the position of the transmitter (for example, the position of transmitter PED 14A or PED 14B) can be found anywhere in a surface of a hyperboloid. If a third receiver (wireless sensor 12C) is added at a third location spaced apart from the two locations of the two respective receivers (wireless sensors 12A and 12B), the third receiver would provide a second TDOA measurement. Hence, the transmitter (PED 14A or PED 14B) would be located on a second hyperboloid. The intersection of the first and second hyperboloids describes a curve on which the transmitter may be positioned. If a fourth receiver is added at a fourth location spaced apart from the three locations of the three respective receivers (wireless sensors 12A, 12B and 12C), the fourth receiver would provide a third TDOA measurement. Hence, the transmitter PED 14A or PED 14B) would be located on a third hyperboloid. The intersection of the first, the second and the third hyperboloids describes a point on which the transmitter (e.g., PED 14A or PED 14B) may be located.

However, in the present case, what is known is the RSSI of the signal at various frequency channels f1, f2, f3, . . . , fN, not the time difference of arrival (TDOA) per se. Hence, one method of multilateration uses a statistical method. In the multilateration process, experimental measurements of signal strength (RSSI) are taken to determine a relationship between the distance and the RSSI. In general, the distance d is related to the RSSI value b by following equation.

d=d₀10^{[(b0-b)/10np]} (15)

where d₀ is an initialization distance corresponding to the RSSI value b₀. For example, b₀ corresponds to the RSSI measured at a distance do of 1 meter. The parameter np is an environmental factor which reflects the environment in which the transmitter (e.g., PED 14A) and receiver (e.g., the sensor 12A) are located. The parameter np is dependent upon the presence of objects, such as trees, cars, walls, furniture, etc., between the transmitter and receiver.

As discussed above, the RSSI value is not known precisely. The measured RSSI of the received signal has a mean RSSI value and a standard deviation. The standard deviation of the RSSI is decreased or reduced by applying a time-window to the Fourier transform of the received signal, as described in the above paragraphs. However, even with an appropriate selection of a time-window, the RSSI is still captured with a certain variance, i.e., the RSSI has a certain standard deviation albeit smaller than the of standard deviation of the RSSI of the received signal prior to applying the time-window procedure.

The environmental factor np can be determined experimentally. By performing an experiment and measuring at various distances the mean RSSI value and the standard deviation around the mean RSSI value, a set of data or a graph of the RSSI vs. the distance can be obtained. From the RSSI vs. distance measurements, the inverse function distance vs. RSSI can be derived. However, in order to perform a best fit to this set of data, a probability distribution function (pdf) is used. The probability distribution function defines the probability that a transmitter transmitting a signal with a con RSSI will be at a certain distance from the receiver. In other words, the probability distribution function provides the probability that a transmitter transmitting a signal with a RSSI value b₁ will be located at a distance d₁ from the receiver. Assuming a Gaussian probability distribution function for each distance measurement around the mean distance, a best fit is determined for the data set distance vs. RSSI and the environmental factor can be determined.

A Kolmogorov-Smirnov test or K-S test can be performed to determine whether the selected Gaussian probability distribution function used to provide a fit for the distance vs. RSSI provides the best for the set of data.

Using the best fit for the distance vs. RSSI values, the environmental parameter np can be computed. Hence, using the equation (15), a measurement of an RSSI value would provide a direct determination of the distance.

The time domain representation of the signal can provide useful information regarding the relationship between a propagation time of the signal in the time domain and a “true” timing of the signal. Specifically, the being time of the line-of-sight signal in the time domain may not correspond to the true arrival time of the signal. However, in the frequency domain, the time difference Δt between the transmission of two consecutive signals S1 (f1) and S2(f2) centered around, respectively, frequencies f1 and f2 can be set as desired. For example, the time difference Δt between the two signals S1(f1) and S2(f2) can be set at 1.23 picoseconds which corresponds to the difference in time between the two frequencies 901 MHz and 902 MHz. The signals S1(f1) and S2(f2) in the frequency domain can be each transformed to signals S1(t1) and S2(t2) in the time domain, using for example a Fourier transform. The signals S1(t1) and S2(t2) would be centered around, respectively, times t1 and t2. The time difference (t2−t1) is not necessarily equal to the time difference Δt between the two signals S1(f1) and S2(t2)(By finding the relationship between the time difference t2−t1 and the time difference Δt, it may be possible to relate the “true” time difference Δt with the propagation time of the signals in the time domain. In other words, a calibration of the timing of the signals in the time domain to the “true” difference in time Δt can be achieved. This will provide an insight on the nature of the relationship between the propagation time of the signals and the true time and thus may provide a tool to determine which wireless sensor is closer to the PED and/or to decrease the localization uncertainty.

In the above paragraphs, the position determination algorithm uses the RSSI values collected or received from the PEDs (e.g., PED 14A and PED 14B). However, alternatively or in addition, the RSSI values can also be collected from the sensors (e.g., sensors 12A, 12B and 12C). In which case, in addition or alternatively to functioning in an uplink configuration, the network system 10 may also function in a downlink configuration.

In a downlink configuration, the wireless sensor 12A communicates with PED 14A and PED 14B in a wide band channel comprising a plurality of frequencies f1 through fN in a specific range of frequencies [f1 . . . FN]. For example, in one embodiment the frequencies f1 through fN can be frequencies in the ISM band 902 MHz to 928 MHz in which f1 is centered around 902 MHz, f2 is centered around 903 MHz, f3 is centered around 904 MHz, . . . , and fN is centered around 928 M where N is equal to 27. However, any frequency band can be selected. In addition, any number of frequencies inside the frequency band can be used.

For example, the PED 14A (which acts as a receiver) can receive downstream data signals from wireless sensors 12A, 12B and 12C (which act as transmitters). The PED 14A can capture the RSSI value of the signals from each of the wireless sensors 12A, 12B and 12C. The PED 14A can then pass on the RSSI value of the signal from the wireless sensor 12A, the RSSI value of the signal from the wireless sensor 12B, and/or the RSSI value of the signal from the wireless sensor 12C, to the command and control center 12 via one or more of the wireless sensors 12A, 12B, 12C. In one embodiment, the command and control center 16 executes a time-window algorithm for the determination of location of a receiver (e.g. PED 14A) in the network using the collected RSSI values from each of the sensors 12A, 12B and 12C. The time window algorithm is described in the above paragraphs in the case of an uplink configuration in which the RSSI values are collected from the PEDs (e.g. PED 14A). The same time window algorithm is applicable for the case where the RSSI values are collected from the wireless sensors (e.g., wireless sensor 12A). In the downlink configuration, however, the phase is computed using the Hilbert transform of the natural logarithm of the frequency samples collected from the wireless sensors. Specifically, the phase can be computed using the amplitude or RSSIs of the signals at the respective frequency components f1, f2, f3, . . . , fN collected from the wireless sensors (e.g., sensor 12A).

Similar to the uplink configuration, a Fourier transform or other appropriate transform, such as a Laplace transform or the like, is applied to the signal (with the above calculated phase) in the frequency domain to obtain a representation of the signal in the time domain. Similarly to the uplink configuration, a time window can be applied to the signal in the time domain to eliminate or reduce multipath.

After substantially eliminating the multipath components of the signal using an appropriate window, an inverse Fourier Transform can be applied on the signal in the time domain to return to a signal in the frequency domain and recreate the frequency scalar values corresponding to the RSSI of the signal, in the same way described above with respect to the uplink configuration.

Similar to the upon configuration, in the process of transmitting a signal from a transmitter, for example, from wireless sensor 12A to a receiver (e.g., PED 14A), in the downlink configuration, the signal may encounter reflections in the transmission path. In this situation, the receiver PED 14A may receive a plural of signals (for example, two signals) each of which carries the same information but shifted in time. As a result, the signal received by the receiver PED 14A would be a sum of the two signals shifted in time relative to each other. For example, one received signal would correspond to a non-reflected signal while the other signal would correspond to a reflected signal. The difference in time between the two signals corresponds to the difference between the arrival time of the non-reflected signal and the arrival time of the reflected signal to the receiver due to path differences or multipath differences between the two signals. This difference in time creates uncertainty in the location determination of the receiver (e.g., PED 14A).

Similarly to the multilateration procedure described above in the case of an uplink configuration, a multilateration procedure can also be devised in the case of a downlink configuration.

As discussed above, the RSSI value is not known precisely. The measured RSSI of the received signal (received by the PEDs) has a mean RSSI value and a standard deviation. The standard deviation of the RSSI is decreased or reduced by applying a time window to the Fourier transform of the received signal, as described in the above paragraphs. However, as explained in the above paragraphs, even with an appropriate selection of a time-window, the RSSI is still captured with a certain variance, i.e., the RSSI has a certain standard deviation albeit smaller than the original standard deviation of the RSSI of the received signal prior to applying the time-window procedure.

Similar to the uplink configuration, by performing an experiment and measuring at various distances the mean RSSI value and the standard deviation around the mean RSSI value, a set of data or a graph of the RSSI vs. the distance can be obtained. From the RSSI vs. distance measurements, the inverse function distance vs. RSSI can be derived. A probability distribution function (pdf) is used in order to find a best fit to this set of data. The probability distribution function defines the probability that a transmitter transmitting a signal with a certain RSSI will be at a certain distance from the receiver. A best fit can be determined for the data set distance vs. RSSI by assuming, for example, a Gaussian probability distribution function for each distance measurement around the mean distance. Using the best fit for the distance vs. RSSI values, the environmental parameter np can be computed. Hence, using the equation (15), a measurement of an RSSI value collected from the sensor (e.g., sensor 12A) would provide a direct determination of the distance of the PED (e.g., PED 14A) relative to the sensor (e.g., sensor 12A) and thus a position of the PED (e.g., PED 14A) in the network can be obtained.

Furthermore, by using both the RSSI value collected from the PED (e.g., PED 14A) and the RSSI value collected from the sensor (e.g., sensor 12A) a distance of the PED (e.g., PED 14A) relative to the sensor (e.g., sensor 12A) can be computed with greater accuracy. As a result, the accuracy in the determination of the position of the PED in the network can be further improved.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

Moreover, the method and apparatus of the present invention, like related apparatus and methods used in the telecommunication arts are complex in nature, are often best practiced by empirically determining the appropriate values of the operating parameters, or by conducting computer simulations to arrive at best design for a given application. Accordingly, all suitable modifications, combinations and equivalents should be considered as falling within the spirit and scope of the invention.

In addition, it should be understood that the figures, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method of determining a location of a transmitter, comprising:
reading a signal strength of a signal transmitted by the transmitter by each of a plurality of receivers, at each frequency in a plurality of frequencies;
extracting phase information using an amplitude of the signal at each of the plurality of frequencies;
applying a transform to the signal in the frequency domain to obtain a representation of the signal in the time domain;
applying a time window to the signal in the time domain to eliminate reflected multipath signals that arrive to the respective receivers later than a line-of-sight signal to obtain a windowed time domain signal; and
calculating a location of the transmitter using the windowed time domain signal.

2. The method of claim 1, wherein calculating the location of the transmitter using the windowed time domain signal comprises:
applying an inverse transform to the windowed time domain signal to return to a signal in the frequency domain; and
performing a multilateration procedure on the signal in the frequency domain to determine the location of the transmitter.

3. The method of claim 2, wherein the applying of the inverse transform comprises applying an inverse Fourier Transform to the windowed time domain signal.

4. The method of claim 1, wherein the applying of the transform comprises applying a Fourier Transform to the signal.

5. A network of receivers, comprising:
a plurality of receivers, each receiver being configured to receive a signal from a transmitter; and
a command and control center in communication with the plurality of receivers, the command and control center being configured to apply a time-window algorithm to the signal received by the receivers to determine the location of the transmitter;
wherein the time window algorithm comprises
determining a signal strength of the signal by each of the plurality of receivers at each frequency in a plurality of frequencies;
extracting phase information using amplitude of the signal at each of the plurality of frequencies;
applying a transform to the signal in the frequency domain to obtain a representation of the signal in the time domain;
applying a time window to the representation of the signal in the time domain to eliminate reflected multipath signals that arrive later than a line-of-sight signal to obtain a windowed time domain signal; and
calculating a location of the transmitter using the windowed time domain signal.

6. The network of transceivers according to claim 5, wherein the calculating a location of the transmitter using the windowed time domain signal comprises:
applying an inverse transform to the windowed time domain signal to obtain a representation of the windowed time signal in the frequency domain; and
performing a multilateration procedure using the representation of the windowed time domain signal in the frequency domain to determine the location of the transmitter.

7. The network of transceivers according to claim 6, wherein the inverse transform is an inverse Fourier Transform.

8. The network of transceivers according to claim 5, wherein the transform is a Fourier Transform.
